(19) United States
(12) Patent Application Publication
(10) Pub. No.: US 2001/0037741 A1
(43) Pub. Date: Nov. 8, 2001

(54) Print unit in a printing press

(76) Inventors: Stephen Franklin, Barrington, NH (US); Wolfgang Schoenberger, Schriesheim (DE)

Correspondence Address: DAVIDSON, DAVIDSON & KAPPEL, LLC, 14th Floor, 485 Seventh Avenue, New York, NY, 10018, US

(21) Appl. No.: 09/802,738

(22) Filed: Mar. 9, 2001

(30) Foreign Application Priority Data
Mar. 13, 2000 (DE) 100 12 189.6

(51) Int. Cl. B41F 13/10; B41F 27/00

(52) U.S. Cl. 101/382.1; 101/375; 101/352.01

(57) ABSTRACT

A print unit (1) in a printing press, which includes an inking roller (2) and a plate cylinder (4), a rubber blanket sleeve (14) being allocated to the inking roller (2), is distinguished by the inking roller (2) being supported in a cantilever-type arrangement on one side wall (34) of the printing press, and the rubber blanket sleeve (14) being able to be axially slid onto and pulled off of the inking roller (2).

### BACKGROUND OF THE INVENTION

The present invention is directed to a print unit in a printing press, in particular in an offset rotary press, the print unit including an inking roller as well as a printing or plate cylinder, with a rubber blanket sleeve being allocated to the inking roller.

In printing-press inking systems, it is generally known to use one or a plurality of inking rollers to apply the printing ink needed for the printing operation to the plate cylinder, the at least one inking roller usually being designed as a rubber roller or being provided, i.e. coated, with a rubber surface.

Also known from the related art are short inking units, in particular anilox inking units, which employ one single plate inking roller that corresponds in diameter to the plate cylinder, to transfer the printing ink to the plate cylinder. By adapting the diameter of the inking roller to that of the plate cylinder, which usually corresponds in diameter to the blanket cylinder as well, one obtains a print output that is free of ghosting. Thus, the inking roller in a short inking unit is much larger and heavier than inking rollers in conventional inking systems. Only with difficulty and by using auxiliary devices, such as roll-out rails, dollies or gantry cranes, is a printer able to remove the inking roller from the inking system for maintenance. The need can arise, for example, to remove the inking roller from the inking system in order to restore a worn rubber surface on the inking roller. Design approaches are known where the rubber surface is permanently vulcanized onto the inking roller, or where a clamping fixture is used to clamp the rubber blanket onto the inking roller.

German Patent Application No. 31 34 796 A1 describes an inking roller having a rubber blanket clamped by a clamping fixture. The rubber blanket can be replaced without necessitating removal of the inking roller. However, the inking roller must be readily accessible in the inking system. This is not conducive to a compact inking system construction. To wash the rubber blanket, one end must first be released from the clamping fixture. The inking roller is then rotated at a reduced speed by one revolution, to enable the other end to be released from the clamping fixture. In a reverse sequence and likewise at a reduced speed of rotation, a new rubber blanket is fitted onto the inking roller. Due to the diminished speed of rotation, this entire operation proceeds very slowly. When working with the described device, the problem arises that the inevitably resulting cylinder gap in this specific embodiment leads to vibrations in the print unit during the press's production run, thereby having an uncontrollable effect on the printed image.

On the other hand, German Patent Publication DE-OS 20 12 649 describes an inking roller which is provided with a sleeve made of a kneadable polyurethane capable of being fitted thereon. The sleeve has a cylindrical construction that is hollow right through, and can be fitted onto the inking roller with the aid of a method likewise described in the German patent Publication DE-OS 20 12 649. For this purpose, the sleeve is encapsulated in a cylindrical form provided with evacuation means, an entrapped air space being formed between the outer wall of the sleeve and the inner wall of the cylindrical form which is subsequently evacuated. This expands the sleeve to the extent that it is able to be fitted in its stretched state onto the inking roller. The vacuum is subsequently canceled, allowing the sleeve to contract again, thereby firmly clamping it onto the inking roller. However, the problem associated with the described method is that, before a new sleeve is fitted on, the inking roller must be removed from the printing press, resulting in considerable downtime for the printing press. Moreover, the document does not explain how the sleeve can be removed again from the print inking roller without being damaged. The problem also arises that the rollers cannot be arbitrarily arranged in the inking system. Rather, due to the need to remove the print inking roller, care must be taken that other rollers not limit access to this roller or make it inaccessible. If the print inking roller is a driven roller, then one must also release it drive, which again further prolongs the printing press downtime to a significant extent.

### SUMMARY OF THE INVENTION

Accordingly, an object of the present invention is to devise a printing press having a print unit, which includes an inking roller which permits a rubber blanket sleeve to be able to slid onto and pulled off from the inking roller quickly and with little expenditure of energy.

The present invention provides a print unit in a printing press, in particular in an offset rotary press, the print unit including an inking roller as well as a plate or printing cylinder, a rubber blanket sleeve being allocated to the inking roller, wherein the inking roller (2) is supported in a cantilever-type arrangement on one side wall (34) of the printing press, and the rubber blanket sleeve (14) is able to be axially slid onto and pulled off of the inking roller (2).

The print unit of the present invention, which is configured in a printing press and includes an inking roller as well as a plate cylinder, a rubber blanket sleeve being assigned to the inking roller, is distinguished by the inking roller being supported in a cantilever-type arrangement on one side wall of the printing press, and by the rubber blanket sleeve being able to be axially slid onto and pulled off of the inking roller. The described refinement according to the present invention of the print unit enables the rubber blanket sleeve assigned to the inking roller to be advantageously replaced by the printer, quickly and without substantial expenditure of energy. For this, it is only necessary to briefly stop the printing press in order to pull the rubber blanket sleeve to be replaced axially off of the inking roller. This can be easily accomplished at the unsupported side of the inking roller. A new rubber blanket sleeve is subsequently slid axially onto the inking roller. The operation of pulling the rubber blanket sleeve off of and sliding it onto the inking roller can be reinforced, for example, by the action of compressed air on the inking roller. The compressed air emerges through openings provided, for example, in the surface of the inking roller, and expands the rubber blanket sleeve when it is being pulled off or slid on and, at the same time, forms an air cushion underneath the sleeve upon which the rubber blanket sleeve can be slid with an easy action or motion. When replacing the rubber blanket sleeve, the embodiment of the print unit according to the present invention advantageously eliminates the need for auxiliary devices, such as roll-out rails, dollies or gantry cranes, to remove the inking roller. In addition, there is no need to release the drive of a driven inking roller in accordance with the present invention from the inking roller when replacing the rubber blanket sleeve.

A further benefit provided by the print unit of the present invention over the related art is that the print unit rollers can be arranged in any arbitrary fashion in the print unit. This is because the printer does not require ready access to the inking roller from its peripheral side in order to remove it from the print unit.

Moreover, the print unit of the present invention makes it possible to change ink, e.g., from cold set to heat set, substantially faster, since a new rubber blanket that is adapted for this purpose to the chemical properties of the particular ink is able to be fitted onto the inking roller quickly and without considerable expenditure of energy.

In addition, when using a print unit in accordance with the present invention, the print impression width remains virtually constant, even in response to a change in the thermal conditions during production printing. This is because rubber blanket sleeves permit the use of a very thin rubber layer, whose expansion only varies slightly in response to thermal fluctuations.

Provision can also be made for the diameter of the inking roller and that of the plate cylinder to be substantially equivalent, which in the case of short inking units, in particular anilox inking units, advantageously ensures a print output that is free of ghosting.

Moreover, the print unit of the present invention can include a blanket or transfer cylinder, it being advantageous to substantially adapt the diameter of the blanket cylinder to that of the inking roller, which likewise promotes a print output that is free of ghosting. However, one can also select a blanket cylinder diameter that is an integral multiple of the inking roller diameter.

In another specific embodiment of the present invention, a cylindrical, axially movable rubber blanket sleeve can likewise be associated with the blanket cylinder. This also makes it substantially simpler for the printer to replace the rubber blanket for the blanket cylinder, quickly and without considerable expenditure of energy, as mentioned above with regard to replacing the rubber blanket of the inking roller. For this, the blanket cylinder can advantageously be supported in a cantilever-type arrangement on one side wall of the printing press and be acted upon by compressed air.

Moreover, the structural design of the inking roller can conform to that of the blanket cylinder, thereby enabling a substantially equivalent cylinder type to be used both as the inking roller and as the blanket cylinder. This advantageously reduces costs for printing press manufacture, as well as for logistics and storage.

Provision can also be made for the inking roller and the blanket cylinder to have associated rubber blanket sleeves that are equivalent in structural design, but, for example, that merely have distinct layer constructions. However, the inking roller and the blanket cylinder can also be assigned identical rubber blanket sleeves. Here, the benefit is derived that the printer only has to stock one type of rubber blanket sleeve, to fit either on the inking roller or on the blanket cylinder, as needed. This reduces the printer's costs for warehousing the rubber blanket sleeves and for related logistics. When rubber blanket sleeves are used having structural designs that conform or that are substantially identical, the costs for washing the rubber blanket sleeves are also diminished, since only one single sleeve-washing apparatus is required for all of the rubber blanket sleeves.

Provision can likewise be made for the rubber blanket sleeves allocated to the inking roller and for those allocated to the blanket cylinder to be interchangeable. This means that rubber blanket sleeves that are not yet worn, but that had been removed merely to wash the inking roller and the blanket cylinder, can again be fitted onto the inking roller or the blanket cylinder following the washing operation, without having to regard the previous allocation of the two rubber blanket sleeves.

To achieve a uniform ink application, another specific embodiment of the present invention provides for the print unit to additionally encompass a plurality of rider rollers, or merely one single rider roller, which is/are assigned, respectively, to the inking roller or to the plate cylinder, and which can be disengaged from and again brought into engagement with the inking roller or the plate cylinder. The fact that the rider rollers can be disengaged from the inking roller and/or from the plate cylinder, for example, automatically as well, is beneficial to the printer, since it makes it easier for him to axially replace the rubber blanket sleeves.

In addition, the print unit can also include an anilox roller or some other roller having depressions, to permit metering of the printing ink onto the inking roller.

A printing press equipped with a print unit according to the present invention is also advantageously additionally provided with a side wall, which features an opening through which the rubber blanket sleeve is able to be axially slid onto and off of the inking roller. The opening in the side wall, which is located at that side wall position where an imaginary prolongation of the inking roller axis contacts the side wall and is large enough to allow the rubber blanket sleeve to be moved through the opening, can be provided, for example, with a swing-away or disengageable bearing. This can reinforce the bearing arrangement for the inking roller during the printing press's production run operation and, at standstill of the printing press, be swung out or disengaged from the inking roller, thereby releasing the opening in the side wall. A multisectional and divisible bearing configuration is also conceivable, so that when the printing press is at a standstill, the individual bearing parts can be disengaged or swung out from the inking roller. The bearing or bearing parts can advantageously be disengaged or swung out automatically as well.

Another embodiment of the printing press according to the present invention provides for the side wall equipped with the opening for replacing the rubber blanket sleeve to be located on the operator side of the printing press. This advantageously enables the printer to replace the rubber blanket sleeve on the same side of the printing press where he performs all other routine activities entailed in the operation of a printing press. Therefore, the thus chosen printing press design has the additional benefit that the free space required for replacing the rubber blanket sleeve does not have to be additionally created on the drive side of the printing press, but that one can revert to the already available, unoccupied space on the operator side of the printing press.

The printing press equipped with a print unit in accordance with the present invention can be a rotary press or a sheet-fed rotary press. It is likewise possible that the printing press equipped with the print unit according to the present invention is an offset printing press or a flexo printing press.

### BRIEF DESCRIPTION OF THE DRAWINGS

The present invention is described in the following with reference to the drawings on the basis of preferred specific embodiments.

FIG. 1 shows a side view of the print unit according to the present invention;

FIG. 2 shows a sectional view of the print unit according to the present invention;

FIG. 3 shows a sectional view of another specific embodiment of the print unit according to the present invention, where the rubber blanket sleeve is pulled off and applied through the opening in the side wall.

In the figures, corresponding features are provided with equivalent reference numerals.

### DETAILED DESCRIPTION

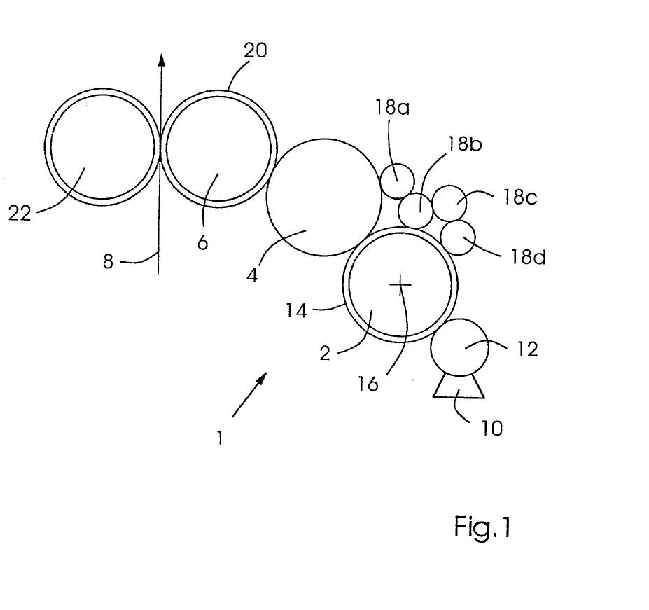

FIG. 1 illustrates a side view of print unit 1 according to the present invention, which has an inking roller 2, a plate cylinder 4, and a blanket cylinder 6. To print on printing material 8, printing ink is applied via a chambered doctor blade 10 to an anilox roller 12 and, from this roller, to inking roller 2 of print unit 1.

In accordance with the present invention, inking roller 2 is provided with a cylindrical rubber blanket sleeve 14, which is able to be slid onto and pulled off of inking roller 2 in the direction of its axis 16. The printing ink is subsequently transferred to plate cylinder 4, thereby advantageously effecting a uniform distribution of the printing ink over the entire length of the plate cylinder by additional rider rollers 18a-d. In this manner, printing ink is uniformly applied to the plate cylinder locations to be printed and is then transferred to blanket cylinder 6. Blanket cylinder 6 is provided, in the manner of inking roller 2, with a rubber blanket sleeve 20, and, in cooperation with an impression cylinder 22, transfers the printed image to printing material carrier 8. At the same time, impression cylinder 22 can also be a blanket cylinder 22 of another print unit, which applies printing ink to the side of printing material carrier 8 facing away from blanket cylinder 6, i.e., to the reverse side of a paper web to be printed on in an offset rotary press having blanket-to-blanket type print units.

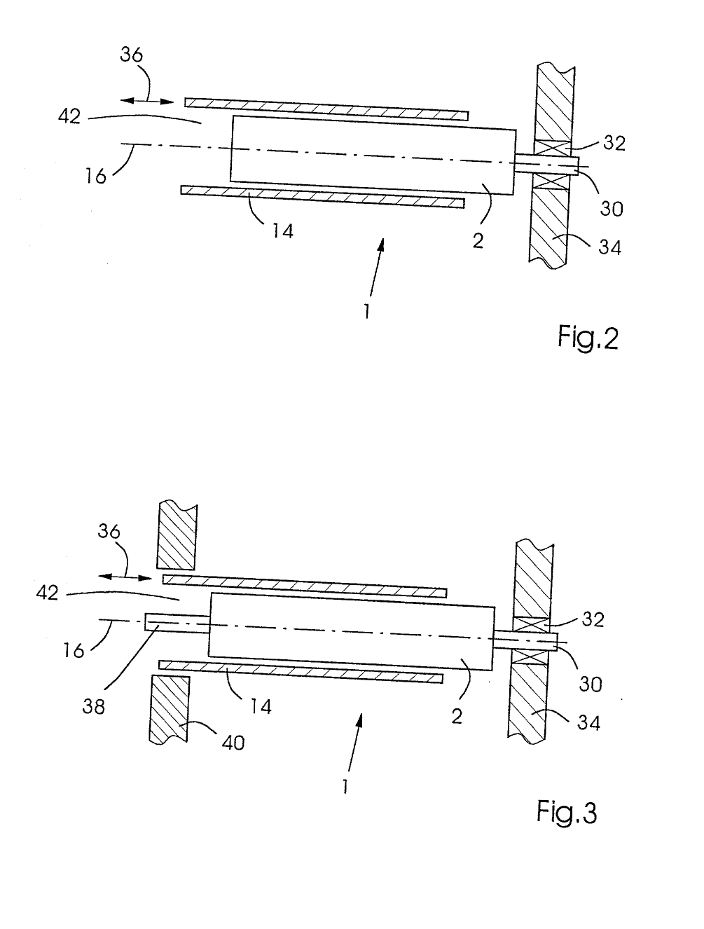

FIG. 2 depicts a sectional view of an inking roller 2 in a print unit 1 according to the present invention. The inking roller 2 is supported in a cantilever-type arrangement by its journal 30 in a bearing 32 of a wall 34 of the printing press. Rubber blanket sleeve 14, which is able to be slid onto and again pulled off of inking roller 2 in the direction of its axis 16, is shown in the middle position to clearly illustrate the pull-on, respectively pull-off processes, double arrow 36 indicating the two moving directions of these processes.

FIG. 3 shows a view of inking roller 2, similar to that shown in FIG. 2, but in this case encompassing a further journal 38 to support the bearing arrangement of inking roller 2. The additional journal is used to support inking roller 2 in side wall 40 during the printing operation. Rubber blanket sleeve 14 is slid onto and off of inking roller 2 through an opening 42 in side wall 40 of the printing press. For this, a bearing assigned to journal 38 is removed beforehand by swinging it out or disengaging it from journal 38, thereby clearing opening 42 in wall 40 of the printing press to permit movement of the rubber blanket sleeve. Once rubber blanket sleeve 14 is slid onto inking roller 2 through opening 42 in wall 40 of the printing press, the bearing assigned to journal 38 is again swung in or engaged in order to support the bearing arrangement of inking roller 2 during the printing operation.

Please cylinder as defined herein may include any image-carrying cylinders, including ones with flat or sleeve-shaped lithographic printing plates attached thereto, or directly-imageable surfaces.

Reference Symbols

1 print unit

2 inking roller

4 plate cylinder

6 blanket cylinder

8 printing material

10 chambered doctor blade

12 anilox roller

14 rubber blanket sleeve

16 axis of the inking roller

18a-18d rider rollers

20 rubber blanket sleeve

22 impression cylinder/ blanket cylinder

30 journal

32 bearing

34 side wall

36 moving directions

38 journal

40 side wall

42 opening in the side wall

What is claimed is:

1. A print unit in a printing press comprising:
a side wall;
a plate cylinder;
an inking roller for inking the plate cylinder, the inking roller being supported in a cantilever-type arrangement on the side wall; and
a blanket sleeve being allocated to the inking roller, the blanket sleeve being axially slidable onto the inking roller and pullable off of the inking roller.

2. The print unit as recited in claim 1 wherein the blanket sleeve includes rubber.

3. The print unit as recited in claim 1 wherein the printing press is an offset rotary press.

4. The print unit as recited in claim 1 wherein a diameter of the inking roller and a plate cylinder diameter of the plate cylinder being equivalent.

5. The print unit as recited in claim 1 further comprising a blanket cylinder supported in a cantilever-type arrangement on the side wall or another side wall of the print unit, a diameter of the inking roller and a blanket cylinder diameter of the blanket cylinder being equivalent.

6. The print unit as recited in claim 5 wherein the blanket cylinder supports another blanket sleeve.

7. The print unit as recited in claim 5 wherein a structural design of the inking roller is similar to that of the blanket cylinder.

8. The print unit as recited in claim 5 wherein the blanket sleeve and another blanket sleeve associated with the blanket cylinder are equivalent in structural design.

9. The print unit as recited in claim 8 wherein the blanket sleeve and the other blanket sleeve are interchangeable.

10. The print unit as recited in claim 1 further comprising a plurality of rider rollers, each rider roller being assigned to the inking roller or to the plate cylinder, the rider rollers being disengageable from the inking roller or the plate cylinder.

11. The print unit as recited in claim 1 further comprising an anilox roller.

12. The print unit as recited in claim 1 wherein the print unit includes a short inking unit.

13. The printing unit as recited in claim 12 wherein the short inking unit is an anilox inking unit.

14. A printing press comprising:
a side wall;
a plate cylinder;
an inking roller for inking the plate cylinder, the inking roller being supported in a cantilever-type arrangement on the side wall; and
a blanket sleeve being allocated to the inking roller, the blanket sleeve being axially slidable onto the inking roller and pullable off of the inking roller.

15. The printing press as recited in claim 14 further comprising a second side wall having an opening through which the blanket sleeve may be axially slid onto and off of the inking roller.

16. The printing press as recited in claim 15 wherein the second side wall is located on an operator side of the printing press.

17. The printing press as recited in claim 14 wherein the printing press is an offset printing press.

18. The printing press as recited in claim 14 wherein the printing press is a flexographic printing press.

19. The printing press as recited in claim 14 wherein the blanket sleeve includes rubber.
